(19) United States
(12) Patent Application Publication
(10) Pub. No.: US 2006/0029646 A1
(43) Pub. Date: Feb. 9, 2006

(54) Anionic-containing feed supplements having a low protein by-pass value

(75) Inventor: William Vanderkooi, Abbotsford (CA)

Correspondence Address: Kathryn J. Doty;Polsinelli Shalton Welte Suelthaus PC, Suite 1100, 100 S. Fourth Street, St. Louis, MO, 63102, US

(73) Assignee: Novus International, Inc.

(21) Appl. No.: 11/198,374

(22) Filed: Aug. 5, 2005

Related U.S. Application Data
(63) Continuation-in-part of application No. 10/910,289, filed on Aug. 4, 2004.

(51) Int. Cl. A23K 1/165

(52) U.S. Cl. 424/442

(57) ABSTRACT

The present invention provides anionic-containing feed supplements having a low protein by-pass value that may be administered to animals. In particular, the invention provides anionic-containing feed supplements that are granular and may be utilized to treat several metabolic disorders in animals, such as hypocalcemia, milk fever, and ketosis.

### CROSS-REFERENCE TO RELATED APPLICATIONS

This application is a continuation-in-part of co-pending U.S. application Ser. No. 10/910,289 filed on Aug. 4, 2004, which is hereby incorporated by reference in its entirety.

### FIELD OF THE INVENTION

The present invention relates to anionic-containing feed supplements having a low protein by-pass value that may be administered to animals. In particular, the invention provides anionic-containing feed supplements that are granular and may be utilized to treat several metabolic disorders in animals, such as hypocalcemia, milk fever, and ketosis. The anionic-containing feed supplement of the invention may also be utilized to treat or prevent a variety of conditions or disorders in an animal resulting from an aberrant urine pH, such as urinary calculi.

### BACKGROUND OF THE INVENTION

Ruminants such as dairy cattle are prone to various diet related metabolic disorders. For example, a dairy cow's blood can become calcium deficient at calving as a direct result of a tremendous amount of calcium being deposited into colostrums and milk. Severe cases of hypocalcemia can result in a metabolic condition called milk fever. Milk fever is a metabolic disorder in which calcium homeostatic mechanisms fail to maintain normal plasma calcium concentrations at the onset of lactation. It is estimated that milk fever may effect up to 10% of cows at calving. As cows become older, the incidence of milk fever increases dramatically, likely due to the decline in the ability to mobilize calcium from bone store and a decline in the active transport of calcium in the intestine. If left untreated, milk fever may result in a disruption of neuromuscular function and ultimately animal death in severe cases.

A widely used treatment for milk fever is to infuse calcium borogluconate solutions into the affected animal. Although this treatment is usually effective, it is relatively expensive to administer and may cause overly high concentrations of plasma calcium. High concentrations of plasma calcium, in turn, may trigger cardiac arrest in some animals.

Less severe cases of hypocalcemia at calving can result in feed intake depression and poor muscle tone, which in turn, can predispose cattle to other secondary medical conditions. These medical conditions, for example, include retained placenta, displaced abomasums, ketosis and mastitis.

Diet, and in particular cations in the diet, is believed to be a contributing factor to the onset of milk fever. The prepartum diet of dairy cattle often includes alfalfa, which has a high concentration of potassium. It has been shown that cations, and in particular potassium, have the effect of reducing absorption of calcium and magnesium into the blood stream, thereby resulting in a greater demand for these minerals. As such, reducing dietary potassium and adding anions in the prepartum animal diet increases calcium mobilization and absorption and facilitates the reestablishment of proper blood calcium levels.

Various strategies for treating or preventing milk fever have been proposed. Each strategy attempts to maintain an appropriate dietary cation/anion difference (DCAD) at the onset of lactation. One approach is to feed inorganic acids, such as combinations of sulphuric and hydrochloric acids, to prepartum cows. Although this approach is effective, inorganic acids are dangerous and difficult to use on a farm in their concentrated liquid form. Another option is to supplement the diet of dairy cattle with anionic salts. Commonly used sources of anions include the chloride ion or sulfur containing ion salts of calcium, ammonium, and magnesium. These anionic salts, however, are often not palatable to animals, which limits their therapeutic value.

Additional strategies for preventing milk fever have included adsorbing anionic compounds onto organic dry material, which can be consumed by the animal. Beet pulp and canola, for example, have been used as dry matter carriers for hydrochloric acid in some dairy feed additives. In particular, one such anionic feed supplement is marketed under the trade name NutriChlor® 18-18. In NutriChlor® 18-18, chloride ion is carried on beet pulp and a canola meal base. While NutriChlor® 18-18 is an effective product, it has drawbacks. For example, the chloride fraction cannot be highly concentrated on organic substrates, which makes transporting the product, particularly for long distances, uneconomical. Moreover, because of the necessity of adding moisture that is contained within the added hydrochloric acid, the blended product containing hydrochloric acid must be dried to produce a dry and flowable product acceptable for transport from the manufacturing facility to the farm. This drying, however, increases the expense of the product and results in a loss of volatile hydrochloric acid, which further reduces product efficacy and posses health risks to workers involved in the manufacturing process.

There is a need for delivering liquid, anionic-containing acids into the diets of certain animals in a form that is more concentrated, palatable, and cost-effective than is currently permitted by the state of the art. A product is also needed that can be administered in a granular form that is flowable. For example, when liquid acids are combined with dry ingredients, the resultant feed product will clump and be difficult to transport, thus creating an undesirable product. Moreover, when the moisture content of a feed is greater than about 15%, the feed is susceptible to mold growth, which reduces palatability and may result in toxic substances produced by mold. One solution is to apply heat to drive off the excess moisture. This step, however, adds additional cost to the manufacturing process of the feed and will result in the volatilization and loss of acid. As such, a need exists for providing an anionic-containing feed supplement that is granular and thus, flowable, as well being palatable, concentrated and cost-effective.

### SUMMARY OF THE INVENTION

Among the several aspects of the current invention, therefore, is the provision of an anionic-containing feed supplement that is flowable, highly palatable, and relatively high in rumen fermentable carbohydrate, and generally having a low protein by-pass value.

One aspect of the invention encompasses a flowable ruminant feed supplement having a protein by-pass value less than approximately 35% by weight protein. The feed supplement generally comprises a granular inorganic substrate; an organic carrier containing from about 20% to about 60% of at least one rumen fermentable carbohydrate; and an inorganic acid. In certain embodiments, the inorganic acid is adsorbed on only the inorganic substrate. In other embodiments, the inorganic acid is adsorbed on only the organic carrier. In still another embodiment, the inorganic acid is adsorbed on both the inorganic substrate and organic carrier. In each embodiment, the inorganic acid typically dissociates to produce an anionic compound when at a pKA of approximately 0 to −9.

In another aspect of the invention a feed ration is provided. The feed ration comprises the anionic-containing feed supplement of the invention, grain portion and a forage portion.

In yet a further aspect of the invention, the anionic-containing feed supplement is administered to an animal to treat certain conditions or disorders. In one embodiment, the feed supplement is administered to the animal to treat a metabolic disorder, such as milk fever. In another embodiment, the feed supplement is administered to the animal to treat urinary calculi.

Other aspects and features of the invention will be in part apparent and in part pointed out hereinafter.

### DETAILED DESCRIPTION OF THE PREFERRED EMBODIMENTS

The present invention provides anionic-containing feed supplements that may be utilized to treat or prevent several disorders or conditions in animals, including certain metabolic disorders. Typically, the anions are adsorbed on an inert, inorganic carrier that is granular and may also be adsorbed on an organic carrier that is high in rumen fermentable carbohydrates. Advantageously, as illustrated in the examples, the feed supplement of the invention provides anions in a concentrated, palatable and granular form that facilitates the flowability characteristics of the feed supplement compared to other commercially available products, such as NutriChlor® 18-18.

Anionic-Containing Feed Supplement

One aspect of the invention provides an anionic-containing feed supplement. Typically, the feed supplement comprises at least one granular, inorganic substrate adsorbed with an inorganic acid. Alternatively, the feed supplement may comprise at least one granular, inorganic substrate in combination with at least one organic carrier high in rumen fermentable carbohydrates. In this embodiment, either one or both of the inorganic substrate and organic carrier are adsorbed with the inorganic acid. The feed supplement may also optionally include one or more additional inorganic additives.

Several inorganic substrates are suitable for use in the present invention. The inorganic substrate will typically be granular, it may be porous and is generally biologically inert. In this context, an inorganic substrate is biologically inert if it is nontoxic and does not generate an appreciable immune reaction when administered to an animal. Non-limiting examples of suitable inorganic substrates include natural or regenerated mineral substrates. One preferred class of mineral substrates is the silicate class. The silicate utilized in the present invention may be selected from a silicate subclass selected from the group consisting of nesosilicate, sorosilicate, inosilicate, cyclosilicate, phyllosilicate and tectosilicate. Examples of suitable nesosilicates include aluminum silicate, iron magnesium manganese aluminum silicate hydroxide, calcium boro-silicate hydroxide, beryllium aluminum silicate hydroxide, iron silicate, magnesium silicate, yttrium iron beryllium silicate, iron aluminum silicate, calcium iron silicate, calcium aluminum silicate, magnesium aluminum silicate, calcium chromium silicate, calcium boro-silicate hydroxide, aluminum silicate, magnesium iron silicate, berylium silicate, calcium titanium silicate, zinc silicate and zirconium silicate. Suitable examples of sorosilicates include beryllium silicate hydroxide, calcium boro-silicate, yttrium cerium calcium aluminum iron silicate hydroxide, calcium aluminum silicate hydroxide, calcium iron aluminum silicate hydroxide, calcium aluminum silicate hydroxide, and calcium iron silicate hydroxide. Non-limiting examples of suitable inosilicates include sodium titanium silicate, calcium silicate, sodium iron silicate, calcium sodium magnesium aluminum iron titanium silicate, calcium magnesium silicate, magnesium silicate, calcium iron silicate, magnesium iron silicate, sodium aluminum iron silicate, lithium aluminum silicate, manganese iron magnesium calcium silicate, sodium manganese calcium silicate hydroxide, copper silicate hydroxide, calcium silicate, calcium magnesium iron silicate hydroxide, magnesium iron silicate hydroxide, iron magnesium silicate hydroxide, potassium iron titanium silicate hydroxide, and calcium iron manganese silicate hydroxide. Suitable examples of cyclosilicates include calcium magnesium iron manganese aluminum borosilicate, potassium lithium calcium titanium zirconium silicate, barium titanium silicate, beryllium aluminum silicate, magnesium aluminum silicate, potassium sodium iron magnesium aluminum silicate, sodium magnesium aluminum boro-silicate hydroxide, and potassium sodium lithium iron manganese aluminum silicate. Examples of suitable phyllosilicates include hydrated potassium sodium calcium silicate, hydrated calcium vanadium silicate, hydrated copper aluminum hydrogen silicate hydroxide, iron magnesium aluminum silicate hydroxide, iron magnesium aluminum silicate hydroxide, lithium aluminum silicate hydroxide, aluminum silicate hydroxide, magnesium silicate hydroxide, hydrated calcium silicate hydroxide, potassium iron magnesium aluminum silicate hydroxide fluoride, potassium lithium aluminum silicate hydroxide fluoride, potassium aluminum silicate hydroxide fluoride, potassium magnesium aluminum silicate hydroxide fluoride, calcium aluminum silicate hydroxide, and iron magnesium silicate hydroxide. Suitable examples of tectosilicates include sodium aluminum silicate, sodium calcium aluminum silicate, calcium aluminum silicate, calcium sodium aluminum silicate, sodium calcium aluminum silicate, potassium aluminum silicate, sodium calcium silicate, silicon dioxide, sodium calcium aluminum silicate carbonate, sodium calcium aluminum silicate sulfate sulfide chloride, sodium aluminum silicate chloride, calcium sodium aluminum silicate chloride carbonate sulfate, hydrated sodium aluminum silicate, hydrated calcium aluminum silicate, hydrated barium potassium aluminum silicate, and hydrated sodium calcium aluminum silicate. In a preferred embodiment, the inorganic substrate is silicon dioxide or sodium benetonite. Depending upon the embodiment, the inorganic substrate may be a mixture of compounds, such as a mixture of one or more of any of the aforementioned silicates.

It will be appreciated by those of skill in the art that the particle size of the inorganic substrate as well as the amount of inorganic substrate included in the feed supplement can and will vary. In general, the average particle size of inorganic substrate will be from about 50 microns to about 180 microns. In another embodiment, the average particle size of the inorganic substrate will be from about 70 microns to about 140 microns. In yet another embodiment, the average particle size of the inorganic substrate will be from about 100 microns to about 120 microns. Depending upon the particle size and its porosity, the inorganic substrate will preferably adsorb from about 50% to about 500% of its weight in moisture. Typically, the amount of inorganic substrate included in the feed supplement will be from about 0.05% to about 7.5% DM of the feed supplement. In another embodiment, the amount of inorganic substrate included in the feed supplement will be from about 0.1% to about 0.5% DM of the feed supplement. In still another embodiment, the amount of inorganic substrate included in the feed supplement will be from about 1.0% to about 3.0% DM of the feed supplement. In yet another embodiment, the amount of inorganic substrate included in the feed supplement will be from about 1.5% to about 2.5% DM of the feed supplement.

The inorganic substrate is typically adsorbed with a suitable inorganic acid. Suitable inorganic acids are acids that dissociate in vivo under physiological conditions to produce a source of anions when administered to the animal. Generally speaking, inorganic acids utilized in the invention typically dissociate to produce an anionic compound at a pKA of from about 3 to about −9. More typically, the inorganic acid will dissociate to produce an anionic compound at a pKA from about 0 to about −9. Even more typically, the inorganic acid utilized will dissociate to produce an anionic compound at a pKA of from about −3 to about −9. As will be appreciated, the amount of inorganic acid adsorbed to the inorganic substrate will vary depending upon the concentration of the inorganic acid. Typically, the amount of inorganic acid will be from about 5% to about 60% DM of the feed supplement. In another embodiment, the amount of inorganic acid will be from about 10% to about 35% DM of the feed supplement. In yet a further embodiment, the amount of inorganic acid will be from about 10% to about 20%. By way of non limiting example, when the inorganic acid is hydrochloric acid that is added from about 10% to about 20% DM of the feed supplement, the hydrochloric acid will typically have a concentration from about 9.0 to about 13 (mole/L). More typically, the inorganic acid will have a concentration from about 10 to about 12 (mole/L). Suitable examples of inorganic acids include nitrous acid, nitric acid, sulfuric acid hydroiodic acid, hydrobromic acid, phosphoric acid, sulfurous acid and hydrochloric acid. In a preferred embodiment, the inorganic acid is sulfurous acid, sulfuric acid or hydrochloric acid. In a particularly preferred embodiment, the inorganic acid is hydrochloric acid. In certain embodiments, the inorganic acid adsorbed on the inorganic substrate or organic carrier may be a mixture of two or more acids, such as a mixture of hydrochloric acid and sulfuric acid.

In some embodiments, the feed supplement will comprise an inorganic substrate, an inorganic acid, and an organic carrier high in rumen fermentable carbohydrates. In some embodiments, the inorganic acid will be adsorbed to the inorganic substrate but not to the organic carrier. In other embodiments, the inorganic acid will be adsorbed to the organic carrier but not to the inorganic substrate. In still other embodiments, the inorganic acid will be adsorbed to both the inorganic substrate and the organic carrier. Suitable organic carriers typically include carriers high in rumen fermentable carbohydrates including carbohydrates that are low in NPN, particularly when the feed supplement is employed to treat metabolic disorders in ruminants such as dairy cattle. The organic carrier is typically low in potassium and low in moisture so that the carbohydrate can effectively adsorb inorganic acid. For example, the organic carrier typically can adsorb from about 10% to about 100% of its weight in moisture. Non-limiting examples of suitable of organic carriers high in rumen fermentable carbohydrates include beet pulp, soybean hulls, alfalfa meal, and canola meal. In one preferred embodiment, the organic carrier utilized in the feed formulation of the invention is a mixture of beet pulp, soybean hulls, and canola meal. Generally speaking, the organic carrier will be composed of about 20% to about 60% of rumen fermentable carbohydrate and the amount of organic carrier will be from about 30% to about 95% DM of the feed supplement. In another embodiment, the amount of organic carrier will be from about 50% to about 85% DM of the feed supplement. In another embodiment, the amount of organic carrier will be from about 70% to about 80% DM of the feed supplement.

The anionic-containing feed supplement of the invention may optionally include other inorganic additives such as calcium chloride, ammonium chloride, calcium carbonate (limestone), and magnesium oxide. When included in the feed supplement, typically the amount of inorganic additive is about 0.05% to about 5.0% DM of the feed supplement.

In the practice of the invention, several formulations of anionic-containing feed supplements are suitable. In one embodiment, by way of non-limiting example, the formulation comprises 0.1% to 5% (on a DM basis) inorganic substrate; 35% to 95% (on a DM basis) organic carrier; and 5% to 60% (on a DM basis) of inorganic acid. For this formulation, the inorganic substrate is typically selected from silica, silicon dioxide and sodium bentonite; the organic carrier selected is a mixture of beat pulp, soybean hulls, alfalfa and canola meal, and the inorganic acid is selected from sulfuric acid and hydrochloric acid. Optionally, each formulation of this embodiment may include from 0.05% to about 5.0% (on a DM basis) of one or more inorganic additives selected from the group consisting of calcium chloride, ammonium chloride, calcium carbonate (limestone), and magnesium oxide.

In still another embodiment, the formulation comprises from about 2% to about 5% of inorganic substrate (on a DM basis); from about 70% to 80% (on a DM basis) organic carrier; and from about 10% to about 20% (on a DM basis) of inorganic acid. For this formulation, the inorganic substrate is typically selected from silica, silicon dioxide and sodium bentonite; the organic carrier selected is a mixture of beat pulp, soybean hulls, alfalfa and canola meal, and the inorganic acid is selected from sulfuric acid and hydrochloric acid. Optionally, each formulation of this embodiment may include from 0.05% to about 5.0% (on a DM basis) of one or more inorganic additives selected from the group consisting of calcium chloride, ammonium chloride, calcium carbonate (limestone), and magnesium oxide.

In yet another embodiment, the formulation comprises about 2% inorganic substrate (on a DM basis); from about 70% to about 80% (on a DM basis) organic carrier; and about 15% inorganic acid. For this embodiment, the inorganic substrate is typically selected from silica, silicon dioxide and sodium bentonite; the organic carrier selected is a mixture of beat pulp, soybean hulls, alfalfa and canola meal, and the inorganic acid is selected from sulfuric acid and hydrochloric acid. In a preferred alternative for this embodiment, the inorganic substrate is silicon dioxide, the organic carrier is a mixture of soy hulls, beet pulp, and canola meal; and the inorganic acid is hydrochloric acid. Optionally, each formulation of this embodiment may include from 0.05% to about 5.0% (on a DM basis) of one or more inorganic additives selected from the group consisting of calcium chloride, ammonium chloride, calcium carbonate (limestone), and magnesium oxide.

In a preferred embodiment, the anionic-containing feed supplement formulation comprises about 1% to about 2% calcium chloride (on a DM basis), about 3% to about 5% ammonium chloride (on a DM basis); about 15% to about 20% hydrochloric acid (on a DM basis); about 1% to about 3% limestone (on a DM basis); about 18% to about 22% beet pulp (on a DM basis); about 40% to about 45% soy hulls (on a DM basis); about 10% to about 12% canola meal (on a DM basis); and about 1% to about 2% silicon dioxide (on a DM basis).

In a particularly preferred embodiment, the anionic-containing feed supplement formulation comprises about 1% calcium chloride (on a DM basis), about 4.5% ammonium chloride (on a DM basis); about 17.5% hydrochloric acid (on a DM basis); about 2% limestone (on a DM basis); about 19.7% beet pulp (on a DM basis); about 43.1% soy hulls (on a DM basis); about 11% canola meal (on a DM basis); and about 1.2% silicon dioxide (on a DM basis).

Typically, the anionic-containing feed supplement of the invention will have a low protein by-pass value. In one embodiment, the protein by-pass value is approximately less than about 35% by weight protein. In a further embodiment, the protein by-pass value is from approximately 30% to about 35% by weight protein. In still another embodiment, the protein by-pass value is from approximately 20% to about 30% by weight protein. In an additional embodiment, the protein by-pass value is approximately less than about 30% by weight protein. In another embodiment, the protein by-pass value is approximately less than about 25% by weight protein. In still another embodiment, the protein by-pass value is approximately less than about 20% by weight protein. Protein by-pass value of the anionic-containing feed supplement of the invention can be computer calculated by utilizing the Cornell-Penn-Miner Dairy Cattle Ration Analyzer software.

The anionic-containing feed supplement of the invention may be made by methods generally known in the art. In one preferred embodiment, the feed supplement is made in accordance with the process illustrated in Example 1.

Animal Feed Pre-Mixes

Another aspect of the invention comprises an animal feed premix comprising the anionic-containing feed supplement of the invention. Typically, the premix will be added to various formulations of grain concentrates and forages to formulate an animal feed ration. As will be appreciated by the skilled artisan, the particular premix formulation can and will vary depending upon the feed ration and animal that the feed ration will be fed to. In addition to the feed supplement of the invention, the premix may further optionally include one or more of a mixture of natural amino acids, analogs of natural amino acids, such as a hydroxyl analog of methionine (“HMTBA”), vitamins and derivatives thereof, enzymes, animal drugs, hormones, effective microorganisms, organic acids, preservatives, flavors, and inert fats.

In one embodiment, the feed premix will include one or more amino acids. Suitable examples of amino acids, depending upon the formulation, include alanine, arginine, asparagines, aspartate, cysteine, glutamate, glutamine, glycine, histidine, isoleucine, leucine, lysine, methionine, phenylalanine, proline, serine, threonine, tryptophan, tyrosine, and valine. Other amino acids usable as feed additives include, by way of non-limiting example, N-acylamino acids, hydroxy homologue compounds, and physiologically acceptable salts thereof, such as hydrochlorides, hydrosulfates, ammonium salts, potassium salts, calcium salts, magnesium salts and sodium salts of amino acids.

In one preferred embodiment, the anionic-containing feed supplement of the invention will be combined with a hydroxy analog of methionine (“HMTBA”) to form a feed pre-mix. Suitable hydroxyl analogs of methionine include 2-hydroxy-4(methylthio)butanoic acid (sold by Novus International, St. Louis, Mo. under the trade name Alimet®), its salts, esters, amides, and oligomers. Representative salts of HMTBA include the ammonium salt, the stoichiometric and hyperstoichiometric alkaline earth metal salts (e.g., magnesium and calcium), the stoichiometric and hyperstoichiometric alkali metal salts (e.g., lithium, sodium, and potassium), and the stoichiometric and hyperstoichiometric zinc salt. Representative esters of HMTBA include the methyl, ethyl, 2-propyl, butyl, and 3-methylbutyl esters of HMTBA. Representative amides of HMTBA include methylamide, dimethylamide, ethylmethylamide, butylamide, dibutylamide, and butylmethylamide. Representative oligomers of HMTBA include its dimers, trimers, tetramers and oligomers that include a greater number of repeating units.

In still another embodiment, the feed premix will include vitamins or derivatives of vitamins. Examples of suitable vitamins and derivatives thereof include vitamin A, vitamin A palmitate, vitamin A acetate, β-carotene, vitamin D (e.g., D₂, D₃, and D₄), vitamin E, menadione sodium bisulfite, vitamin B (e.g., thiamin, thiamin hydrochloride, riboflavin, nicotinic acid, nicotinic amide, calcium pantothenate, pantothenate choline, pyridoxine hydrochloride, cyanocobalamin, biotin, folic acid, p-aminobenzoic acid), vitamin K, vitamin Q, vitamin F, and vitamin C.

In yet another embodiment, the feed premix will include one or more enzymes. Suitable examples of enzymes include protease, amylase, lipase, cellulase, xylanase, pectinase, phytase, hemicellulase and other physiologically effective enzymes.

In still another embodiment, the feed premix will include a drug approved for use in animals. Non-limiting examples of suitable animal drugs include antibiotics such as tetracycline type (e.g., chlortetracycline and oxytetracycline), amino sugar type, ionophores (e.g., rumensin, virginiamycin, and bambermycin) and macrolide type antibiotics.

In an additional embodiment, the feed premix will include a hormone. Suitable hormones include estrogen, stilbestrol, hexestrol, tyroprotein, glucocorticoids, insulin, glucagon, gastrin, calcitonin, somatotropin, and goitradien.

In a further embodiment, the feed premix will include an effective microorganism. Examples of suitable effective microorganisms include live and dead yeast cultures, which may be formulated as a probiotic. By way of example, such yeast cultures may include one or more of Lactobacillus Acidophilus, Bifedobact Thermophilum, Bifedobat Longhum, Streptococcus Faecium, Sacchromyces cerevisiae, Bacillus pumilus, Bacillus subtilis, Bacillus licheniformis, Lactobacillus acidophilus, Lactobacillus casei, Enterococcus faecium, Bifidobacterium bifidium, Propionibacterium acidipropionici, Propionibacteriium freudenreichii, Aspergillus oryzae, and Bifidobacterium Pscudolongum.

In yet another embodiment, the premix will include an organic acid. Suitable organic acids include malic acid, propionic acid and fumaric acid.

In still another embodiment, the premix will include a preservative. Examples of preservatives include natural and synthetic antioxidants. By way of example, natural antioxidants include vitamins E and C. Synthetic antioxidants include ethoxyquin, butylated hydroxytoluene, and butylated hydroxyanisol. In a preferred embodiment, the antioxidant is ethoxyquin.

In an additional embodiment, the feed premix will include a substance to increase the palatability of the feed ration. Suitable examples of such substances include natural sweeteners, such as molasses, and artificial sweeteners such as saccharin and aspartame.

In a further embodiment, the feed premix will include an inert fat, such as a ruminally inert fat. Suitable examples of ruminally inert fats include megalac, alifet, and carolac. Some commercially available bypass fats are described, for example, in U.S. Pat. Nos. 5,182,126; 5,250,307; 5,391,787; 5,425,963; and 5,456,927 which disclose C14-C22 fatty acids, their glycerides, or their salts including, but not limited to, palmitic, oleic, linoleic, stearic, and lauric compounds.

As will be appreciated by the skilled artisan any of the substance that may be included in the premix of the invention can be used alone or in combination with one another. The concentration of these additives will depend upon the application but, in general, will be between about 0.0001% and about 10% by weight of the dry matter, more preferably between about 0.001% and about 7.5%, most preferably between about 0.01% and about 5%.

Animal Feed Rations

A further aspect of the invention encompasses an animal feed ration that will typically contain the anionic-containing feed supplement or a premix containing the anionic-containing feed supplement. The feed ration may be formulated to meet the nutritional requirements of a variety of animals including ruminants, such as cattle and sheep, pigs, poultry or companion animals, such as dogs and cats. Those of skill in the art can readily formulate a feed ration to meet the energy demands of a particular animal species. Examples of typical feed formulations for a variety of animals are detailed below by way of non-limiting example.

In one embodiment, the feed ration will be formulated for a ruminant and in particular, a dairy cow. In practice, ruminants are typically fed as a ration, commonly referred to as a total mixed ration (TMR), which consists of a forage portion and a grain concentrate portion. The forage portion is typically provided by the farmer and generally consists of haylage or silage, with the forage and grain concentrate portions being mixed by the dairy farmer. The grain concentrate portion is typically prepared by a commercial feed mill and is generally prepared by mixing grains such as corn, soy, and alfalfa with any of a variety of premix items such as those identified above (i.e., vitamins, minerals, molasses, fat sources, synthetic amino acids and a variety of other feedstuffs). These ingredients are blended in commercial feed mills using conventional milling techniques that include augering, mixing, expanding, extruding, and pelleting.

In one preferred embodiment, the feed ration is formulated for a dairy cow. As will be appreciated by a skilled artisan, a feed ration for a dairy cow can and will vary greatly depending upon the cow's stage of production. In this context, stage of production not only refers to whether a dairy cow is dry or lactating, but also the duration of time the cow has been in the dry cycle or the lactation cycle. Milestones in the stage of production include the first 35 days dry, known as “far off;” the last 21 days dry, known as “close-up;” day 0 to day 14 of lactation, known as “fresh;” day 14 to day 80 of lactation, known as “peak milk;” days 80 to 200 of lactation, known as “peak intake;” and days 200 to 330 of lactation. Suitable rations for dairy cattle for the first 35 days dry, day 0 to 14 of lactation and day 14 to 80 of lactation are detailed below.

An example of a suitable dairy cow feed ration for a cow in the first 35 days of the dry cycle is as follows:

| | Percent by Weight (DM basis) |
|---|---|
| Ingredient | of Total Feed Composition |
| Steamrolled Corn | 8.0 |
| Wheat straw | 8.5 |
| Alfalfa hay | 38.0 |
| Corn silage | 41.0 |
| Trace Mineral Salts | 4.5 |

A suitable example of a dairy cow feed ration for a cow at day 0 to 14 of the lactation cycle is as follows:

| | Percent by Weight (DM basis) |
|---|---|
| Ingredient | of Total Feed Composition |
| Steamrolled Corn | 8.0 |
| Soybean meal (44%) | 7.5 |
| Alfalfa hay | 17.0 |
| Corn silage | 47.0 |
| Nutrichlor 18-8 | 16.0 |
| Trace Mineral Salts | 4.5 |

An example of a suitable dairy cow feed ration for a cow at day 14 to 80 of the lactation cycle is as follows:

| | Percent by Weight (DM basis) |
|---|---|
| Ingredient | of Total Feed Composition |
| Steamrolled Corn | 15.0 |
| Soybean meal (44%) | 13.0 |
| Alfalfa hay | 22.0 |
| Corn silage | 21.0 |
| Distillers grains | 8.0 |
| Whole Cottonseed | 10.0 |
| Soyean hulls | 6.5 |
| Trace Mineral Salts | 4.5 |

A feed ration may also be formulated to meet the nutritional requirements of non-dairy cattle, and in particular, feedlot cattle. The percentage of each type of component in the cattle diet (i.e. grain to roughage ratio) depends upon the dietary requirements of the particular animal. By way of example, a feed composition typically fed to feedlot cattle on an intermediate or growing diet would include:

| | Percent by Weight of |
|---|---|
| Ingredient | Total Feed Composition |
| Dehydrated Alfalfa Meal | 25.0 |
| Cottonseed Hulls | 5.0 |
| Steamrolled Corn | 60.0 |
| Soybean meal (44%) | 3.0 |
| Calcium Carbonate | 1.0 |
| Sodium Tripolyphosphate | 0.5 |
| Cane Molasses | 5.0 |
| Trace Mineral Salts | 0.5 |

The intermediate diet contains a moderate energy to roughage ratio and is fed to cattle during their growth stage. After the intermediate diet, a higher energy finishing diet is substituted until the cattle are ready for slaughter. A typical finishing diet would include:

| | Percent by Weight of |
|---|---|
| Ingredient | Total Feed Composition |
| Dehydrated Alfalfa Meal | 5.0 |
| Cottonseed Hulls | 10.0 |
| Steamrolled Corn | 74.8 |
| Soybean meal (44%) | 3.0 |
| Calcium Carbonate | 0.7 |
| Sodium Tripolyphosphate | 0.3 |
| Cane Molasses | 5.0 |

Standard feed formulations are described in E. W. Crampton et al., Applied Animal Nutrition, W. H. Freeman and Company, San Francisco, Calif., 1969 and D. C. Church, Livestock Feeds and Feeding, O & B Books, Corvallis, Oreg., 1977, both of which are incorporated herein by reference.

Uses of the Anionic-Containing Feed Supplement

The anionic-containing feed supplement of the invention may be utilized to treat a variety of conditions or disorders in animals. In some embodiments, the animal will be a ruminant such as a cow, sheep, or goat. In a particularly preferred embodiment, the ruminant is a dairy cow. In other embodiments, the animal is a pig, poultry, or horse. In another embodiment, the animal may be a companion animal, such as a dog or cat.

In certain embodiments, the disorder or condition may result from a failure of the animal's calcium homeostatic mechanisms. For example, such a failure can occur when an animal gives birth and a tremendous amount of calcium is put into colostrum and milk. This is particularly true for animals that produce large quantities of milk, such as dairy cattle or lactating sows. In severe cases, milk fever may result. In less severe cases, the animal may have a depressed appetite that may result in ketosis. As such, the present invention provides a method for treating disorders or conditions resulting from a failure of the animal's calcium homeostatic mechanisms, such as hypocalcemia, milk fever and ketosis. The method comprises administering to the animal a therapeutically effective amount of the anionic-containing supplement of the invention. It is believed that administering the anionic-containing compounds of the invention increases calcium mobilization and absorption and facilitates the reestablishment of proper blood calcium levels. While the amount of anionic containing compound needed to re-establish calcium homeostasis will vary depending upon the cow's diet, typically the amount of anionic-containing feed supplement administered is from about 0.5 to about 1.5 kg per cow per day. In a preferred embodiment, the amount of anionic-containing feed supplement administered is from about 0.75 to 1.0 kg per cow per day.

The anionic-containing feed supplements of the invention, when administered to an animal in appropriate amounts, lowers the pH of the animal's urine. As such, in some embodiments, the disorder or condition is one that is benefited by lowering the pH of the animal's urine. By way of non-limiting example, one such condition is urinary calculi. Urinary calculi is a condition that occurs when undissolved minerals (especially calcium) form stones that can block the urinary tract of the animal. It may be caused when animals are provided diets that are high protein, such as feedlot finishing rations, or by unbalanced diets, such as diets not having a proper balance of minerals. Without being bound by any particular theory, it is believed that the anionic-containing feed supplement of the invention lowers the pH of the animal's urine and facilitates dissolution of the stone resulting from urinary calculi. It is also believed that, when administered to the animal in an effective amount, the anionic-containing feed supplement will also aide in preventing the formation of a stone. While certain types of animals have a higher incidence of developing urinary calculi, such as animals on high protein diets, the method of the invention may be effective in a variety of animals including for the treatment or prevention of urinary calculi in companion animals, such as dogs and cats. A skilled artisan can readily determine the amount of anionic-containing feed supplement to administer to a particular animal for treatment or prevention of urinary calculi.

All publications, patents, patent applications and other references cited in this application are herein incorporated by reference in their entirety as if each individual publication, patent, patent application or other reference were specifically and individually indicated to be incorporated by reference.

Definitions

“DCAD” is an abbreviation for dietary cation/anion difference.

“DM” is an abbreviation for dry matter.

“Fermentable Carbohydrate,” as used herein, means ingredients that are high in rumen fermentable carbohydrate. In this context, a substantial portion of the carbohydrate is fermented in the rumen of the animal if the animal is a ruminant.

“Flowable,” as used herein, means a feed supplement that is substantially free flowing and substantially resistant to clumping. Example 2 details a test to determine whether a particular supplement is “flowable.”

“Liquid Acid,” as used herein, means an acid present in the feed supplement in the liquid phase. For example, substantially all of the liquid acid may be physically adsorbed on the surface on of a solid phase. A liquid acid includes inorganic acids, such as hydrochloric acid, and organic acids such as malic acid.

“Protein by-pass value,” as used herein refers to the amount of dietary protein by weight that is not degraded in the rumen of a ruminant.

The phrase “therapeutically-effective” or “effective amount” are intended to qualify the amount of anionic-containing feed supplement that will achieve the goal of improvement in disorder severity and the frequency of incidence over no treatment.

As various changes could be made in the above compounds, products and methods without departing from the scope of the invention, it is intended that all matter contained in the above description and in the examples given below, shall be interpreted as illustrative and not in a limiting sense.

### EXAMPLES

The following examples illustrate the anionic-containing feed supplement of the invention. In particular, Example 1 details a method for making one formulation of the feed supplement and Example 2 illustrates the feed supplement's improved flowability characteristics compared to NutriChlor® 18-18.

### Example 1

### Method of Manufacturing the Anionic-Containing Feed Supplement

An anionic-containing feed supplement having the following formulation was made:

| | |
|---|---|
| Silicon dioxide | 2.0% of DM |
| Hydrochloric Acid | 15.0% of DM |
| Beet Pulp | 26.0% of DM |
| Soybean Hulls | 51.0% of DM |
| Calcium Chloride | 3.0% of DM |
| Ammonium Chloride | 3.0% DM |

A stationary mixer was used to combine all ingredients. First, 400 kg of beet pulp was added to a first mixer and the mixing process was started. Next, 950 kg of soybean hulls were added to the mixer and the mixing process was allowed to continue. After approximately 2 minutes of mixing, 350 kg of concentrated hydrochloric acid was sprayed into the mixing chamber of the first mixer, while continuously mixing the soybean hulls and beet pulp. Upon completion of the addition of the hydrochloric acid to the first mixer, the mixture was allowed to mix continuously for another 5 minutes to ensure that the hydrochloric acid was substantially adsorbed on to the beet pulp and soybean hulls. The mixture was then transferred by auger to a second mixer and 22 kg of silica was added and the resulting mixture was continuously mixed for 2 minutes. While mixing continued in the second mixer, 15 kg of limestone, 38 kg of ammonium chloride, and 10 kg of calcium chloride were adding the resulting formulation was mixed for an additional 5 minutes after the addition of the last ingredient. The resulting anionic-containing feed supplement was substantially dry and flowable The feed supplement was transferred by auger to a holding bin and was ready to be placed into bags for shipment.

### Example 2

### Flowability of the Anionic-Containing Feed Supplement

To test the flowability of the feed supplement of the invention, a flowability test was conducted comparing the feed formulation detailed in Example 1 to NutriChlor® 18-18, a product manufactured by the applicant without an inorganic substrate. Both feed supplements were compressed into separate cylinders 6 cm in diameter by 15 cm in height until the volume of the cylinders was reduced to a height of 10 cm. The cylinders were opened at both ends. The cylinders were then removed by removing the compression, then lifting vertically, allowing each feed supplement in the cylinders to stand on its own in the cylindrical form.

The NutriChlor® 18-18 product prepared without the addition of an inorganic substrate maintained its cylindrical shape, having a diameter of 6 cm and a height of 11.5 cm. By contrast, the feed supplement of the present invention having an inorganic substrate collapsed into a pyrimidical shape with a height of 2.5 cm and a diameter of 12.5 cm. This experiment demonstrates that the feed supplements made without the addition of inorganic substrate, such as NutriChlor® 18-18, is susceptible to becoming compacted during transportation and handling, and is resistance to being free-flowing. A feed supplement of the invention, however, having the inorganic substrate is free flowing and thus, facilitates ease of handling and transporting liquid acids in a dry form.

What is claimed is:

1. A flowable ruminant feed supplement having a protein by-pass value less than approximately 35% by weight protein, the feed supplement comprising:
(a) a granular inorganic substrate;
(b) an organic carrier containing from about 20% to about 60% of at least one rumen fermentable carbohydrate; and
(c) an inorganic acid, the inorganic acid being adsorbed on at least one of the inorganic substrate or organic carrier, the inorganic acid dissociating to produce an anionic compound when at a pKA of approximately 0 to −9.

2. The feed supplement of claim 1, wherein the granular inorganic substrate is a silicate selected from the group of silicate subclass consisting of nesosilicate, sorosilicate, inosilicate, cyclosilicate, phyllosilicate and tectosilicate.

3. The feed supplement of claim 1, wherein the granular inorganic substrate is selected from the group consisting of silica, silicon dioxide and sodium bentonite.

4. The feed supplement of claim 1, wherein the organic carrier comprises a mixture of soy hulls, beet pulp, alfalfa and canola meal.

5. The feed supplement of claim 3, wherein the organic carrier consists of a mixture of soy hulls, beet pulp and canola meal.

6. The feed supplement of claim 1, wherein the inorganic acid is hydrochloric acid or sulfuric acid.

7. The feed supplement of claim 5, wherein the inorganic acid is hydrochloric acid.

8. The feed supplement of claim 1, wherein the protein by-pass value is from about 30% to about 35% by weight protein.

9. The feed supplement of claim 1, wherein the protein by-pass value is from about 20% to about 25% by weight protein.

10. The feed supplement of claim 1, wherein the formulation comprises from about 0.1% to about 5% (DM) of inorganic substrate; from about 35% to about 95% (DM) of organic carrier; and from about 5% to about 60% (DM) of an inorganic acid having a concentration from about 9.0 to about 13.0 (mole/L).

11. The feed supplement of claim 1, wherein the formulation comprises from about 2.0% to about 5% (DM) of inorganic substrate; from about 70% to about 80% (DM) of organic carrier; and from about 10% to about 20% (DM) of an inorganic acid having a concentration from about 10.0 to about 12.0 (mole/L).

12. The feed supplement of claim 11, wherein the inorganic substrate is silicon dioxide, the organic carrier is a mixture consisting of soy hulls, beet pulp and canola meal, and the inorganic acid is hydrochloric acid.

13. The feed supplement of claim 12, further comprises from about 0.05% to about 5.0% by weight of an inorganic additive selected from the group consisting of calcium chloride, ammonium chloride, calcium carbonate, and magnesium oxide.

14. The feed supplement of claim 1, further comprising a hydroxyl analog of methionine.

15. The feed supplement of claim 14, wherein the hydroxyl analog of methionine is 2-hydroxy-4(methylthio)butanoic acid or a salt, ester, or amide of 2-hydroxy-4(methylthio)butanoic acid.

16. A flowable ruminant feed supplement, the feed supplement comprising:
(a) about 1% to about 2% (DM) calcium chloride;
(b) about 3% to about 5% (DM) ammonium chloride;
(c) about 15% to about 20% (DM) hydrochloric acid having a concentration from about 10.0 to about 12.0 (mole/L);
(d) about 1% to about 3% (DM) limestone;
(e) about 18% to about 22% (DM) beet pulp;
(f) about 40% to about 45% (DM) soy hulls;
(g) about 10% to about 12% canola meal (DM); and
(h) about 1% to about 2% (DM) silicon dioxide.

17. The feed supplement of claim 16, further comprising a hydroxyl analog of methionine.

18. The feed supplement of claim 17, wherein the hydroxyl analog of methionine is 2-hydroxy-4(methylthio)butanoic acid or a salt, ester, or amide of 2-hydroxy-4(methylthio)butanoic acid.

19. A flowable ruminant feed supplement, the feed supplement consisting of:
(a) about 1% to about 2% (DM) calcium chloride;
(b) about 3% to about 5% (DM) ammonium chloride;
(c) about 15% to about 20% (DM) hydrochloric acid having a concentration from about 10.0 to about 12.0 (mole/L);
(d) about 1% to about 3% (DM) limestone;
(e) about 18% to about 22% (DM) beet pulp;
(f) about 40% to about 45% (DM) soy hulls;
(g) about 10% to about 12% canola meal (DM); and
(h) about 1% to about 2% (DM) silicon dioxide.

20. A ruminant feed ration, the feed ration comprising a grain portion, a forage portion and an anionic-containing feed supplement, the feed supplement having a protein by-pass value less than approximately 35% by weight protein, the feed supplement comprising:
(a) a granular inorganic substrate;
(b) an organic carrier containing from about 20% to about 60% of at least one rumen fermentable carbohydrate; and
(c) an inorganic acid, the inorganic acid being adsorbed on at least one of the inorganic substrate or organic carrier, the inorganic acid dissociating to produce an anionic compound when at a pKA of approximately 0 to −9.

21. The feed ration of claim 20, wherein the forage portion is haylage or silage.

22. The feed ration of claim 20, further comprising a hydroxyl analog of methionine.

23. The feed supplement of claim 22, wherein the hydroxyl analog of methionine is 2-hydroxy-4(methylthio)butanoic acid or a salt, ester, or amide of 2-hydroxy-4(methylthio)butanoic acid.

24. The feed ration of claim 22, further comprising ethoxyquin.

25. A method for treating a metabolic disorder in an animal, the metabolic disorder resulting from a failure of the animal's calcium homeostatic mechanisms, the method comprising administering to the animal an effective amount of an anionic-containing feed supplement, the feed supplement having a protein by-pass value less than approximately 35% by weight protein, the feed supplement comprising:
(a) a granular inorganic substrate;
(b) an organic carrier containing from about 20% to about 60% of at least one rumen fermentable carbohydrate; and
(c) an inorganic acid, the inorganic acid being adsorbed on at least one of the inorganic substrate or organic carrier, the inorganic acid dissociating to produce an anionic compound when at a pKA of approximately 0 to −9.

26. The method of claim 25, wherein the disorder is selected from the group consisting of milk fever, hypocalcemia, and ketosis.

27. The method of claim 26, wherein the animal is selected from the group consisting of a ruminant, a pig, a horse and a companion animal.

28. The method of claim 25, wherein the disorder is milk fever and the animal is a ruminant.

29. The method of claim 28, wherein the ruminant is a dairy cow.

30. The method of claim 29, wherein the dairy cow is administered from about 0.5 to about 1.5 kg per day.

31. A method for lowering the pH of urine in an animal, the method comprising administering to the animal an effective amount of an anionic-containing feed supplement, the feed supplement having a protein by-pass value less than approximately 35% by weight protein, the feed supplement comprising:
(a) a granular inorganic substrate;
(b) an organic carrier containing from about 20% to about 60% of at least one rumen fermentable carbohydrate; and
(c) an inorganic acid, the inorganic acid being adsorbed on at least one of the inorganic substrate or organic carrier, the inorganic acid dissociating to produce an anionic compound when at a pKA of approximately 0 to −9.

32. The method of claim 31, wherein the anionic-containing feed supplement is administered to the animal to treat urinary calculi.

33. The method of claim 31, wherein the animal is selected from the group consisting of a ruminant, a pig, a horse, and a companion animal.

34. The method of claim 31, wherein the animal is a companion animal.

35. The method of claim 34, wherein the companion animal is a dog or cat.
